(19) United States
(12) Patent Application Publication
(10) Pub. No.: US 2026/0155433 A1
(43) Pub. Date: Jun. 4, 2026

(54) METHOD FOR MANUFACTURING A SOLID SULFIDE ELECTROLYTE

(71) Applicant: Umicore, Brussels (BE)

(72) Inventor: Solveig KJELDGAARD, Arendal (NO)

(21) Appl. No.: 18/876,838

(22) PCT Filed: Jun. 23, 2023
(86) PCT No.: PCT/EP2023/067072

§ 371 Date: Dec. 19, 2024

(30) Foreign Application Priority Data
Jun. 24, 2022 (EP) 22290043.3

(51) Int. Cl. H01M 10/0562; C01D 15/00

(52) U.S. Cl. CPC H01M 10/0562; C01D 15/00; C01P 2002/72; C01P 2002/86; C01P 2006/40; C01P 2006/80; H01M 2300/008

(57) ABSTRACT

The present invention relates a method for manufacturing a solid sulfide electrolyte and the solid sulfide electrolyte obtainable from said method. The present inventors surprisingly have found that by mixing of the solid electrolyte precursor mixture with an organic liquid other than ethanol or methanol followed by heat-treating affording the solid sulfur electrolyte, the resulting conductivity of the solid sulfur electrolyte is higher.

### TECHNICAL FIELD AND BACKGROUND

This invention relates to a method for manufacturing a solid sulfide electrolyte and the solid sulfide electrolyte obtainable from said method.

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to a high energy density and a high reference electrode potential.

However, electrolytes conventionally used in lithium secondary batteries are liquid electrolytes such as organic solvents. Accordingly, safety problems such as leakage of electrolytes and risk of fire may continuously occur.

Recently, solid state batteries including solid electrolytes, rather than liquid electrolytes, have been used to improve the safety feature of the lithium secondary battery and have attracted much attention. For example, solid electrolytes are typically safer than liquid electrolytes due to non-combustible or flame retardant properties.

Solid electrolytes may include oxide-based solid electrolytes, polymer-based electrolytes and sulfide-based electrolytes. Sulfide-based electrolytes have been generally used due to their higher lithium ionic conductivity range compared to oxide-based and polymer-based solid electrolytes, such as sulfide-based solid electrolytes having an argyrodite type crystal structure.

Conventionally, a method for manufacturing a solid sulfide electrolyte uses ethanol as a solvent or liquid. Typically the precursors of LiCl, P₂S₅ and Li₂S are dissolved in ethanol, the mixture is stirred, the solvent removed and the resulting mixture calcinated to the resulting solid sulfide electrolyte such as Li₆PS₅Cl and Li₆PS₅Br. Examples of this liquid-based approach using ethanol are described in US 2020/0119394 A1 and US 2019/0173127 A1. US 2019/0074544 A1 describes a similar synthetic pathway using Li₃PS₄, LiCl and Li₂S as precursors dissolved in ethanol. Ethanol has been considered a suitable solvent for the synthesis of Li₆PS₅Cl, since the precursors completely dissolve in ethanol thereby driving the reaction towards the formation of the solid sulfide electrolyte. However, it has been observed by the present inventors that alcohol as a solvent, such as ethanol or methanol, is detrimental for the resulting conductivity of the solid sulfide electrolyte.

Hence, there is a need to provide a method for manufacturing a solid sulfide electrolyte which uses a different liquid as ethanol and does not result in a solid sulfide electrolyte having a low conductivity.

It is an object of the present invention to provide a method for manufacturing a solid sulfide electrolyte.

It is a further object of the present invention to provide the solid sulfide electrolyte obtainable from said method.

It is a further object of the present invention to provide a solid sulfide electrolyte having an argyrodite-type crystal structure.

It is a further object of the present invention to provide a battery comprising said solid sulfide electrolyte.

### SUMMARY OF THE INVENTION

In a first aspect an object of the present invention is achieved by providing a method for manufacturing a solid sulfide electrolyte by providing a solid electrolyte precursor mixture and a liquid not comprising a hydroxyl moiety.

The present inventors surprisingly have found that by mixing of the solid electrolyte precursor mixture with an organic liquid other than ethanol or methanol followed by heat-treating affording the solid sulfur electrolyte, the resulting conductivity of the solid sulfur electrolyte is higher as compared to the solid sulfur argyrodite obtained after mixing of the solid electrolyte precursor mixture with ethanol or methanol.

Without wishing to be bound by any theory, the present inventors believe that the alcoholic solvent nucleophilically attacks the PS₄³⁻ units of the solid sulfur electrolyte thereby decomposing the sulfur-based solid electrolytes and forming PO₄³⁻, PSO₃³⁻ and/or PS₂O₂³⁻ decompositions products, such as Li₃PO₄. These decompositions products are detrimental for the resulting conductivities of the solid sulfide electrolytes. A possible solution is to recrystallize the solid sulfide electrolyte in ethanol thereby obtaining a pure compound exhibiting a high conductivity (ACS Appl. Energy Mater. 2018, 1, 8, 3622-3629). Nonetheless, decomposition of the solid sulfur electrolyte or the solid sulfur electrolyte precursors results in an overall loss of yield of the solid sulfide electrolyte.

In a further aspect the invention provides the solid sulfide electrolyte obtainable by the method according to the invention.

In a further aspect the invention provides a solid sulfide electrolyte having an argyrodite-type crystal structure.

In a further aspect the invention provides a battery comprising the solid sulfide electrolyte according to the invention.

### BRIEF DESCRIPTION OF THE FIGURES

FIG. 1: XRD spectra of EX1-5 and CEX1-2 before calcination using different liquids (ACN=acetonitrile, DME=dimethoxyethane, EA=ethyl acetate, DMF=dimethylformamide).

FIG. 2: XRD spectra of EX1-5 and CEX1-2 after calcination using different liquids (ACN=acetonitrile, DME=dimethoxyethane, EA=ethyl acetate, DMF=dimethylformamide).

FIG. 3: ³¹P NMR of EX1 before and after calcination and CEX1 before and after calcination.

### DETAILED DESCRIPTION

In the drawings and the following detailed description, preferred embodiments are described in detail to enable practice of the invention. Although the invention is described with reference to these specific preferred embodiments, it will be understood that the invention is not limited to these preferred embodiments. In contrast, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein refers to a cell or battery that includes only solid or substantially solid-state components such as solid electrodes (e.g. anode and cathode) and solid electrolyte.

The term “argyrodite-type crystal structure” as used herein refers to a crystal structure having a crystal structure or system similar to naturally existing Ag₈GeS₆ and Li₇S₆ (Argyrodite). The argyrodite-type crystal may be orthorhombic having Pna21 space group and having a unit cell of a=15.149, b=7 476, c=10 589 [Å]; Z=4. In some embodiments the argyrodite-type crystal structure may also be empirically determined for example, by X-ray diffraction by observing peaks around at 2θ=15.5±1°, 18±1°, 26±1°, 30.5±1° and 32±1° using CuKα-ray.

The ionic conductivity as referred to herein, refers to the ionic conductivity determined by electrochemical impedance spectroscopy (EIS) at 25° C. It is preferably determined with stainless steel plungers on pressed samples, with a pressure of 5 T on a sample with a diameter of 10 mm and a total mass of the sample of 120 mg, wherein a pressure of 80 kg/cm² was applied. A suitable conductivity analyzer is a potentiostat with frequency analyzer such as is available from Biologic.

The electronic conductivity as referred to herein, refers to electronic conductivity determined at 25° C. It is preferably determined with stainless steel plungers on pressed samples, with a pressure of 5 T on a sample with a diameter of 10 mm and a total mass of the sample of 120 mg, wherein a pressure of 80 kg/cm² was applied. Preferably, the ionic conductivity is measured via step-wise potentiostatic polarization at 0.2, 0.4, 0.6 V and 0.8 V.

X-ray diffraction (XRD) as referred to herein, refers to XRD experiments performed using a Bruker D8 Advanced diffractometer with Cu radiation (λ₁=1.54056 Å, λ₂=1.54439 Å).

### Method for Manufacturing

As discussed above in a first aspect the invention provides a method for manufacturing a solid sulfide electrolyte comprising the consecutive steps:
(i) providing an electrolyte precursor mixture comprising a solid electrolyte precursor mixture comprising Li₂S, Li₃PS₄ and LiX and a liquid not comprising a hydroxyl moiety;
(ii) mixing of the electrolyte precursor mixture obtained in step (i); and
(iii) heat-treating of the mixed electrolyte precursor mixture obtained in step (ii) to obtain a solid sulfide electrolyte having an argyrodite-type crystal structure; wherein X is a halogen selected from F, Cl, Br, I or a combination thereof.

The term “solid electrolyte precursor mixture” as used herein refers to a electrolyte precursor mixture being essentially free of any liquid. The term “essentially free of liquid” means that the solid electrolyte precursor mixture comprises less than 10 wt. % of a liquid by total weight of the solid electrolyte precursor mixture, preferably less than 7.5 wt. %, more preferably less than 5 wt. %, even more preferably less than 2.5 wt. %, most preferably less than 1 wt. % by total weight of the solid electrolyte precursor mixture. In a more preferred embodiment the solid electrolyte precursor mixture comprises less than 1000 ppm of a liquid by total weight of the solid electrolyte precursor mixture, preferably less than 500 ppm, more preferably less than 100 ppm, even more preferably less than 50 ppm, most preferably less than 10 ppm by total weight of the solid electrolyte precursor mixture.

In the context of the present invention a liquid shall be considered to be an organic or aqueous compound which is liquid in standard conditions for temperature and pressure as defined by the IUPAC. Hereby the boiling point and the melting point shall be considered to be the boiling point and the melting point at standard atmospheric pressure, i.e. at 101325 Pa. As appreciated by the skilled person the presence of the organic liquid can be determined via thermogravimetric analysis (TGA) or nuclear magnetic resonance (NMR) spectroscopy and the presence of the aqueous liquid, such as water, can be determined via Karl Fisher titration.

The term “solid sulfide electrolyte” as used herein refers to a solid sulfide electrolyte being essentially free of any liquid. The term “essentially free of liquid” means that the solid sulfide electrolyte comprises less than 10 wt. % of a liquid by total weight of the solid sulfide electrolyte, preferably less than 7.5 wt. %, more preferably less than 5 wt. %, even more preferably less than 2.5 wt. %, most preferably less than 1 wt. % by total weight of the solid sulfide electrolyte. In a more preferred embodiment the solid sulfide electrolyte comprises less than 1000 ppm of a liquid by total weight of the solid sulfide electrolyte, preferably less than 500 ppm, more preferably less than 100 ppm, even more preferably less than 50 ppm, most preferably less than 10 ppm by total weight of the solid sulfide electrolyte.

As appreciated by the skilled person every crystal structure of Li₃PS₄ can be used in the method of the invention, in particular γ-, α- and β-polymorph of Li₃PS₄.

A preferred embodiment of the invention is the method according to the invention, wherein the solid sulfide electrolyte is represented by formula (I)

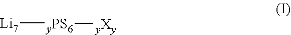

wherein y=0.8-1.7. As appreciated by the skilled person when y is 0.8 to 1.7, it is possible to obtain a solid sulfide electrolyte having an argyrodite-type crystal structure. In a more preferred embodiment y is 0.8 to 1.7, preferably y is 0.9 or more and 1.6 or less, and more preferably y is 1.0 or more and 1.4 or less.

A highly preferred embodiment is the method according to the invention, wherein the solid sulfide electrolyte is represented by formula (II)

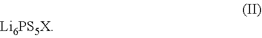

A preferred embodiment is the method according to the invention, wherein X═F, Cl, Br, I or combinations thereof; preferably X═Cl, Br or combinations thereof; more preferably X═Cl.

In accordance with preferred embodiments of the invention, the solid sulfide electrolyte is provided wherein at least 50 mol % of X represents Cl, preferably at least 80 mol % of X represents Cl, most preferably X represents Cl.

In accordance with preferred embodiments of the invention, the solid sulfide electrolyte is provided wherein X represents F, Cl, Br, I or a combination thereof and wherein at least 50 mol % of X represents Cl, preferably at least 80 mol % of X represents Cl.

In accordance with preferred embodiments of the invention, the solid sulfide electrolyte is provided wherein at least 50 mol % of X represents F, preferably at least 80 mol % of X represents F, most preferably X represents F.

In accordance with preferred embodiments of the invention, the solid sulfide electrolyte is provided wherein X represents F, Cl, Br, I or a combination thereof and wherein at least 50 mol % of X represents Br, preferably at least 80 mol % of X represents Br.

In accordance with preferred embodiments of the invention, the solid sulfide electrolyte is provided wherein at least 50 mol % of X represents Br, preferably at least 80 mol % of X represents Br, most preferably X represents Br.

In accordance with preferred embodiments of the invention, the solid sulfide electrolyte is provided wherein X represents F, Cl, Br, I or a combination thereof and wherein at least 50 mol % of X represents Br, preferably at least 80 mol % of X represents Br.

In accordance with preferred embodiments of the invention, the solid sulfide electrolyte is provided wherein at least 50 mol % of X represents I, preferably at least 80 mol % of X represents I, most preferably X represents I.

In accordance with preferred embodiments of the invention, the solid sulfide electrolyte is provided wherein X represents F, Cl, Br, I or a combination thereof and wherein at least 50 mol % of X represents I, preferably at least 80 mol % of X represents I.

A highly preferred embodiment is the method according to the invention, wherein X═F, Cl, Br or I; preferably X═Cl or Br; more preferably X═Cl.

A preferred embodiment is the method according to the invention, wherein the molar ratios of Li₂S:Li₃PS₄:LiX are between (0.5-1.5):(0.5-1.5):(0.5-1.5), preferably between (0.75-1.25):(0.75-1.25):(0.75-1.25), more preferably between (0.9-1.1):(0.9-1.1):(0.9-1.1). In a more preferred embodiment the molar ratios of Li₂S:Li₃PS₄:LiX are between (0.95-1.05):(0.95-1.05):(0.95-1.05), preferably between (0.98-1.02):(0.98-1.02):(0.98-1.02), more preferably between (0.99-1.01):(0.99-1.01):(0.99-1.01). In a highly preferred embodiment the molar ratios of Li₂S:Li₃PS₄:LiX are about 1:1:1.

A preferred embodiment is the method according to the invention, wherein the molar ratios of Li:P:S:X are between (5-7):(0.5-1.5):(4-6):(0.5-1.5), preferably between (5.5-6.5):(0.75-1.25):(4.5-5.5):(0.75-1.25), more preferably between (5.75-6.25):(0.9-1.1):(4.75-5.25):(0.9-1.1). In a more preferred embodiment of the invention, the molar ratios of Li:P:S:X are between (5.9-6.1):(0.95-1.05):(4.9-5.1):(0.95-1.05), preferably between (5.95-6.05):(0.98-1.02):(4.95-5.05):(0.98-1.02), more preferably between (5.98-6.02):(0.99-1.01):(4.98-5.02):(0.99-1.01). In a highly preferred embodiment the molar ratios of Li:P:S:X are about 6:1:5:1.

As appreciated by the skilled person the liquid not comprising a hydroxyl moiety is any liquid which does not contain a hydroxyl functional group (also known as hydroxy functional group or —OH group) as functional moiety of the liquid. Examples of liquids which do not comply with this definition are alcohols, such as ethanol and methanol, water or glycols.

A preferred embodiment is the method according to the invention, wherein the liquid not comprising a hydroxyl moiety is an organic liquid. In certain preferred embodiments the liquid not comprising a hydroxyl moiety is an aprotic liquid. As appreciated by the skilled person an aprotic liquid is a liquid, wherein the hydrogen atoms are not directly connected to an electronegative atom such O and N. Worded differently an aprotic liquid does not contain an O—H or an N—H functional moiety. In certain preferred embodiments an aprotic liquid is a liquid that lacks an acidic proton.

A more preferred embodiment is the method according to the invention, wherein the liquid not comprising a hydroxyl moiety is selected from the group consisting of a hydrocarbon, an ester, a ketone, an aldehyde, an ether, a nitrile, an amine, an amide, a carbonate, a sulfone, a sulfoxide, a sulfonate, a thiol, a fluorine-based compound and a combination thereof; preferably the group consisting of an amide, an ester, an ether, an nitrile, an aromatic hydrocarbon and a combination thereof, most preferably the group consisting of an amide, an ether, an nitrile, an aromatic hydrocarbon and a combination thereof. In certain preferred embodiment the liquid not comprising a hydroxyl moiety is selected from the group consisting of an aromatic hydrocarbon, an ester, an ether, a nitrile, an amide, a sulfoxide, a thiol, and a combination thereof, preferably the liquid not comprising a hydroxyl moiety is selected from the group consisting of an aromatic hydrocarbon, an ester, an ether, a nitrile, an amide, a sulfoxide and a thiol. Examples of a hydrocarbon are linear or branched hydrocarbons such as linear or branched pentane, linear or branched hexane, linear or branched octane, linear or branched nonane, linear or branched decane, linear or branched undecane and linear or branched dodecane. Further examples of a hydrocarbon are a cyclic alkane such as cyclopentane, cyclohexane, cycloheptane or cyclooctane. Further examples of a hydrocarbon are an aromatic hydrocarbon such as benzene, toluene, o-, m- or p-xylene. Further examples of a hydrocarbon in the present invention are alkyl halides such as chloroform, methyl chloride or dichloromethane. Examples of an ester are methyl acetate or ethyl acetate (EtOAc). Examples of a ketone are acetone or butanone. Examples of an ether are dimethyl ether, diethyl ether, methyl ethyl ether, tetrahydrofuran or dimethoxyethane (DME). Example of a carbonate is dimethyl carbonate. Examples of amines are pyridine, aniline, hydrazine, triethylamine, diethylamine, monoethylamine, ethylene diamine or ammonia. Examples of amides are dimethylformamide (DMF) or N-methyl-2-pyrrolidone. Example of a sulfoxide is dimethylsulfoxide (DMSO). Example of a sulfone is sulfolane. Example of a thiol is butanethiol. Example of a nitrile is acetonitrile. Examples of a fluorine-based compounds is benzene fluoride; heptane fluoride; 2,3-dihydroperfluoropentane and 1,1,2,2,3,3,4-heptfluorocyclopentane.

In a highly preferred embodiment the liquid not comprising a hydroxyl moiety is selected from the group consisting of DMF, EtOAc, DME, CH₃CN, xylene, DMSO, butanethiol, ethylene diamine and a combination thereof, preferably the group consisting of DMF, EtOAc, DME, CH₃CN, xylene, and a combination thereof, most preferably the group consisting of the group consisting of DMF, DME, CH₃CN, xylene and DMSO.

As demonstrated in the appended examples, the solid sulfur electrolyte is not formed before the heat-treating of the mixed electrolyte precursor mixture, and hence the liquid not comprising a hydroxyl moiety serves as a mixing medium for the electrolyte precursor mixture. The present inventors surprisingly found that it is not necessary that one or more precursors and/or the solid sulfide electrolyte is completely dissolved in the liquid not comprising a hydroxyl moiety. In contrast, when ethanol is used as a liquid, all precursors and the solid sulfide electrolyte are completely dissolved and formation of the solid sulfide electrolyte is already observed before calcination. However, as demonstrated in the appended examples, using ethanol as a liquid in the method for manufacturing the solid sulfide electrolyte is detrimental for the ionic and/or electronic conductivity of the solid sulfide electrolyte.

In preferred embodiments the amount of the solid electrolyte precursor mixture is more than 0.5 wt. % based on the total weight of the solid electrolyte precursor mixture and the liquid not comprising a hydroxyl moiety, preferably more than 1 wt. %, more preferably more than 2.5 wt. % based on the total weight of the solid electrolyte precursor mixture and the liquid not comprising a hydroxyl moiety. In preferred embodiments the amount of the solid electrolyte precursor mixture is less than 15 wt. %, based on the total weight of the solid electrolyte precursor mixture and the liquid not comprising a hydroxyl moiety, preferably less than 10 wt. %, more preferably less than 7.5 wt. % based on the total weight of the solid electrolyte precursor mixture and the liquid not comprising a hydroxyl moiety. In preferred embodiments the amount of the solid electrolyte precursor mixture is between 0.5-15 wt. % based on the total weight of the solid electrolyte precursor mixture and the liquid not comprising a hydroxyl moiety, preferably between 1-10 wt. %, more preferably between 2.5-7.5 wt. % based on the total weight of the solid electrolyte precursor mixture and the liquid not comprising a hydroxyl moiety.

In a preferred embodiment the electrolyte precursor mixture comprises at least 90 wt. % of the liquid not comprising a hydroxyl moiety by total weight of the electrolyte precursor mixture, more preferably at least 92 wt. % of the liquid not comprising a hydroxyl moiety, most preferably at least 94 wt. % of the liquid not comprising a hydroxyl moiety by total weight of the electrolyte precursor mixture.

In a preferred embodiment the electrolyte precursor mixture comprises between 90-99 wt. % of the liquid not comprising a hydroxyl moiety by total weight of the electrolyte precursor mixture, more preferably between 92-98 wt. % of the liquid not comprising a hydroxyl moiety, most preferably between 94-97 wt. % of the liquid not comprising a hydroxyl moiety by total weight of the electrolyte precursor mixture.

In preferred embodiments the electrolyte precursor mixture comprises between 0.5-15 wt. % solid electrolyte precursor mixture based by total weight of the electrolyte precursor mixture, preferably between 1-10 wt. % solid electrolyte precursor mixture, more preferably between 2.5-7.5 wt. % solid electrolyte precursor mixture based by total weight of the electrolyte precursor mixture.

In certain highly preferred embodiments the electrolyte precursor mixture consists of the solid electrolyte precursor mixture and the liquid not comprising a hydroxyl moiety.

A preferred embodiment is the method according to the invention, wherein step (ii) further comprises the following steps:
(ii)a mixing of the electrolyte precursor mixture obtained in step (i), and
(ii)b drying of the mixed electrolyte precursor obtained in step (ii)a thereby affording a solid electrolyte mixture.

The term “solid electrolyte mixture” as used herein refers to an electrolyte mixture being essentially free of any liquid. The term “essentially free of liquid” means that the solid electrolyte mixture comprises less than 10 wt. % of a liquid by total weight of the solid electrolyte mixture, preferably less than 7.5 wt. %, more preferably less than 5 wt. %, even more preferably less than 2.5 wt. %, most preferably less than 1 wt. % by total weight of the solid electrolyte mixture. In a more preferred embodiment the solid electrolyte mixture comprises less than 1000 ppm of a liquid by total weight of the solid electrolyte mixture, preferably less than 500 ppm, more preferably less than 100 ppm, even more preferably less than 50 ppm, most preferably less than 10 ppm by total weight of the solid electrolyte mixture.

A preferred embodiment is the method according to the invention, wherein the mixing of the electrolyte precursor mixture with a mixing speed between 100 and 1500 rpm, preferably between 200 and 1000 rpm, most preferably between 400 and 800 rpm.

A preferred embodiment is the method according to the invention, wherein the mixing of the electrolyte precursor mixture in step (ii) and/or step (ii)a occurs at a mixing time of at least 1 min, preferably at least 0.5 hour, more preferably at least 1 hour, even more preferably at least 2 hours, even more preferably at least 5 hours, most preferably at least 10 hours. A preferred embodiment is the method according to the invention, wherein the mixing occurs at a mixing time of less than 72 hours, preferably less than 60 hours, more preferably less than 50 hours, even more preferably less than 40 hours, even more preferably less than 36 hours, most preferably less than 30 hours. A preferred embodiment is the method according to the invention by mixing of the solid electrolyte precursor mixture at a mixing time between 1 hour and 72 hours, preferably between 2 hours and 60 hours, more preferably between 10 hours and 30 hours.

In accordance with highly preferred embodiments of the invention mixing of the solid electrolyte precursor mixture in step (ii) and/or step (ii)a occurs:
with a mixing speed between 100 and 1500 rpm, preferably between 200 and 1000 rpm, most preferably between 400 and 800 rpm; and
at a mixing time between 1 hour and 72 hours, preferably between 2 hours and 60 hours, more preferably between 10 hours and 30 hours.

A preferred embodiment is the method according the invention, wherein the mixing of the electrolyte precursor mixture occurs a temperature of at least 5° C., preferably at least 10° C., more preferably at least 15° C. A preferred embodiment is the method according to the invention, wherein the mixing occurs at a temperature of less than 50° C., preferably less than 40° C., more preferably less than 30° C. A preferred embodiment is the method according to the invention, wherein the mixing occurs at a temperature between 5 and 50° C., preferably a temperature between 1° and 40° C., more preferably a temperature between 15 and 30° C.

A preferred embodiment is the drying of the mixed electrolyte precursor in step (ii)b, wherein the liquid not comprising a hydroxyl moiety is removed by heating of the mixed electrolyte precursor obtained in step (ii)a. Preferably the liquid not comprising a hydroxyl moiety is removed by heating under reduced pressure. As appreciated by the skilled person, when the liquid not comprising a hydroxyl moiety has a high(er) boiling point, the temperature of the heating of the mixed electrolyte precursor obtained in step (ii)a should be increased and/or the pressure should be decreased as much as possible thereby removing the liquid not comprising a hydroxyl moiety more easily. Examples of the drying of the mixed electrolyte precursor, but not limited to the invention, are rotavapor evaporation, vacuum distillation and/or drying in an oven or vacuum oven.

A preferred embodiment is the method according to the invention, wherein the heat-treating in step (iii) occurs at a temperature of at least 100° C., preferably at least 200° C., more preferably at least 300° C., more preferably at least 400° C., even more preferably at least 450° C., most preferably at least 500° C. A preferred embodiment is the method according to the invention, wherein the heat-treating in step (iii) occurs at a temperature of less than 1000° C., preferably less than 900° C., more preferably less than 800° C., even more preferably less than 700° C., even more preferably less than 600° C., most preferably less than 550° C. A preferred embodiment is the method according to the invention, wherein the heat-treating in step (iii) occurs at a temperature between 10° and 1000° C., preferably between 30° and 700° C., more preferably between 35° and 650° C.

As appreciated by the skilled person the heat-treating of the mixed electrolyte mixture in step (iii) to obtain a solid sulfide electrolyte having an argyrodite-type crystal structure is also known as calcination of the solid electrolyte mixture towards the formation of the solid sulfide electrolyte having an argyrodite-type crystal.

A preferred embodiment is the method according to the invention, wherein the heat-treating in step (iii) occurs under an inert atmosphere, preferably an argon atmosphere, or under an atmosphere comprising a hydrogen sulfide gas, preferably an atmosphere consisting of a hydrogen sulfide gas.

A preferred embodiment is the method according to the invention, wherein the heat-treating of the solid electrolyte mixture in step (iii) is at least 1 min, preferably at least 0.5 hour, more preferably at least 1 hour, even more preferably at least 1.5 hours, most preferably at least 2 hours. A preferred embodiment is the method according to the invention, wherein the heat-treating of the solid electrolyte mixture in step (iii) is less than 48 hours, preferably less than 24 hours, more preferably less than 18 hours, even more preferably less than 12 hours, most preferably less than 10 hours. A preferred embodiment is the method according to the invention, wherein the heat-treating of the solid electrolyte mixture in step (iii) is between 0.5 hour and 24 hours, preferably between 1 hours and 12 hours, more preferably between 1.5 hours and 10 hours.

### The Solid Sulfide Electrolyte

A second aspect of the invention is providing a solid sulfide electrolyte obtainable by the method according to the invention. As appreciated by the skilled person all embodiments related to the method for manufacturing the solid sulfide electrolyte according to the invention equally apply to the solid sulfide electrolyte obtainable by the method according to the invention.

A preferred embodiment is the solid sulfide electrolyte according to the invention, which does not substantially contain a phase formed from Li₂S, LiCl, Li₄P₂S₆ and/or Li₃PS₄ as determined by XRD, wherein the peak intensities of Li₂S, LiCl, Li₄P₂S₆ and/or Li₃PS₄ are less than 30% of the peak intensities of Li₆PS₅Cl, preferably less than 25%, more preferably less than 20%, even more preferably less than 10%, most preferably less than 5%. In accordance with preferred embodiment the solid sulfide electrolyte according to the invention has a purity of at least 70% as determined by XRD, preferably a purity of at least 75%, more preferably a purity of at least 80%, even more preferably a purity of at least 90%, most preferably a purity of at least 95%.

A preferred embodiment is the solid sulfide electrolyte according to the invention having XRD patterns at around 2θ=15.5±1°, 18±1°, 26±1°, 30.5±1° and 32±1 using CuKα-ray.

A preferred embodiment is the solid sulfide electrolyte according to the invention, which does not substantially contain a phase formed from PO₄³⁻, such as Li₃PO₄, as determined by NMR, preferably by ³¹P NMR, wherein the peak area of PO₄³⁻ is less than 30% relative to the total area, preferably less than 25% relative to the total area, more preferably less than 20% relative to the total area, even more preferably less than 10% relative to the total area, most preferably less than 5% relative to the total area. A preferred embodiment is the solid sulfide electrolyte according to the invention, which does not substantially contain a phase formed from PSO₃³⁻, such as Li₃PSO₃, as determined by NMR, preferably by ³¹P NMR, wherein the peak area of PSO₃³⁻ is less than 30% relative to the total area, preferably less than 25% relative to the total area, more preferably less than 20% relative to the total area, even more preferably less than 10% relative to the total area, most preferably less than 5% relative to the total area. A preferred embodiment is the solid sulfide electrolyte according to the invention, which does not substantially contain a phase formed from PS₂O₂³⁻, such as Li₃PS₂O₄, as determined by NMR, preferably by ³¹P NMR, wherein the peak area of PS₂O₂³⁻ is less than 30% relative to the total area, preferably less than 25% relative to the total area, more preferably less than 20% relative to the total area, even more preferably less than 10% relative to the total area, most preferably less than 5% relative to the total area. A preferred embodiment is the solid sulfide electrolyte according to the invention, which does not substantially contain a phase formed from P₂S₇⁴⁻ as determined by NMR, preferably by ³¹P NMR, wherein the peak area of P₂S₇⁴⁻ is less than 30% relative to the total area, preferably less than 25% relative to the total area, more preferably less than 20% relative to the total area, even more preferably less than 10% relative to the total area, most preferably less than 5% relative to the total area. In accordance with preferred embodiments the solid sulfide electrolyte according to the invention has a purity of at least 70% as determined by NMR, preferably ³¹P NMR, preferably a purity of at least 75%, more preferably a purity of at least 80%, even more preferably a purity of at least 90%, most preferably a purity of at least 95%. As appreciated by the skilled person PS₄³⁻ has a signal between 80 and 90 ppm, preferably about 85 ppm, as determined by ³¹P NMR, PO₄³⁻ has a signal between 5 and 15 ppm, preferably about 10 ppm, as determined by ³¹P NMR, PSO₃³⁻ has a signal between 30 and 40 ppm, preferably about 35 ppm, as determined by ³¹P NMR, PS₂O₂³⁻ has a signal between 65 and 75 ppm, preferably about 70 ppm, as determined by ³¹P NMR and P₂S₇⁴⁻ has a signal between 90 and 100 ppm, preferably about 95 ppm, as determined by ³¹P NMR.

A preferred embodiment is the solid sulfide electrolyte according to the invention having an ionic conductivity of at least 1 mS/cm, preferably at least 1.5 mS/cm, most preferably at least 2 mS/cm. A preferred embodiment is the solid sulfide electrolyte according to the invention having an ionic conductivity of less than 5 mS/cm, more preferably less than 4 mS/cm, most preferably less than 3 mS/cm. A preferred embodiment is the solid sulfide electrolyte according to the invention having a ionic conductivity between 1 and 5 mS/cm, preferably between 1.5 and 4 mS/cm, most preferably between 2 and 3 mS/cm.

A preferred embodiment is the solid sulfide electrolyte according to the invention having an electronic conductivity of at least 1×10⁻⁷ mS/cm, preferably at least 1×10⁻⁶ mS/cm, most preferably at least 1×10⁻⁵ mS/cm. A preferred embodiment is the solid sulfide electrolyte according to the invention having an electronic conductivity of less than 1×10⁻² mS/cm, preferably less than 1×10⁻³ mS/cm, most preferably less than 1×10⁻⁴ mS/cm. A preferred embodiment is the solid sulfide electrolyte according to the invention having an electronic conductivity between 1×10⁻⁷ and 1×10⁻² mS/cm, preferably between 1×10⁻⁶ and 1×10⁻³ mS/cm, most preferably between 1×10⁻⁵ and 1×10⁻⁴ mS/cm.

A third aspect of the invention is providing a solid sulfide electrolyte having an argyrodite-type crystal structure. As appreciated by the skilled person all embodiments related to the method for manufacturing the solid sulfide electrolyte according to the invention and all embodiments related to the solid sulfide electrolyte obtainable by the method for manufacturing the solid sulfide electrolyte equally apply to the solid sulfide electrolyte having an argyrodite-type crystal structure according to the invention.

A preferred embodiment is the solid sulfide electrolyte according to the invention, which does not substantially contain a phase formed from Li₂S, LiCl, Li₄P₂S₆ and/or Li₃PS₄ as determined by XRD, wherein the peak intensities of Li₂S, LiCl, Li₄P₂S₆ and/or Li₃PS₄ are less than 30% of the peak intensities of Li₆PS₅Cl, preferably less than 25%, more preferably less than 20%, even more preferably less than 10%, most preferably less than 5%. In accordance with preferred embodiment the solid sulfide electrolyte according to the invention has a purity of at least 70% as determined by XRD, preferably a purity of at least 75%, more preferably a purity of at least 80%, even more preferably a purity of at least 90%, most preferably a purity of at least 95%.

A preferred embodiment is the solid sulfide electrolyte according to the invention having XRD patterns at around 2θ=15.5±1°, 18±1°, 26±1°, 30.5±1° and 32±1° using CuKα-ray.

A preferred embodiment is the solid sulfide electrolyte according to the invention, which does not substantially contain a phase formed from PO₄³⁻, such as Li₃PO₄, as determined by NMR, preferably by ³¹P NMR, wherein the peak area of PO₄³⁻ is less than 30% relative to the total area, preferably less than 25% relative to the total area, more preferably less than 20% relative to the total area, even more preferably less than 10% relative to the total area, most preferably less than 5% relative to the total area. A preferred embodiment is the solid sulfide electrolyte according to the invention, which does not substantially contain a phase formed from PSO₃³⁻, such as Li₃PSO₃, as determined by NMR, preferably by ³¹P NMR, wherein the peak area of PSO₃³⁻ is less than 30% relative to the total area, preferably less than 25% relative to the total area, more preferably less than 20% relative to the total area, even more preferably less than 10% relative to the total area, most preferably less than 5% relative to the total area. A preferred embodiment is the solid sulfide electrolyte according to the invention, which does not substantially contain a phase formed from PS₂O₂³⁻, such as Li₃PS₂O₄, as determined by NMR, preferably by ³¹P NMR, wherein the peak area of PS₂O₂³⁻ is less than 30% relative to the total area, preferably less than 25% relative to the total area, more preferably less than 20% relative to the total area, even more preferably less than 10% relative to the total area, most preferably less than 5% relative to the total area. A preferred embodiment is the solid sulfide electrolyte according to the invention, which does not substantially contain a phase formed from P₂S₇⁴⁻ as determined by NMR, preferably by ³¹P NMR, wherein the peak area of P₂S₇⁴⁻ is less than 30% relative to the total area, preferably less than 25% relative to the total area, more preferably less than 20% relative to the total area, even more preferably less than 10% relative to the total area, most preferably less than 5% relative to the total area. In accordance with preferred embodiments the solid sulfide electrolyte according to the invention has a purity of at least 70% as determined by NMR, preferably ³¹P NMR, preferably a purity of at least 75%, more preferably a purity of at least 80%, even more preferably a purity of at least 90%, most preferably a purity of at least 95%. As appreciated by the skilled person PS₄³⁻ has a signal between 80 and 90 ppm, preferably about 85 ppm, as determined by ³¹P NMR, PO₄³⁻ has a signal between 5 and 15 ppm, preferably about 10 ppm, as determined by ³¹P NMR, PSO₃³⁻ has a signal between 30 and 40 ppm, preferably about 35 ppm, as determined by ³¹P NMR, PS₂O₂³⁻ has a signal between 65 and 75 ppm, preferably about 70 ppm, as determined by ³¹P NMR and P₂S₇⁴⁻ has a signal between 90 and 100 ppm, preferably about 95 ppm, as determined by ³¹P NMR.

A preferred embodiment is the solid sulfide electrolyte according to the invention having an ionic conductivity of at least 1 mS/cm, preferably at least 1.5 mS/cm, most preferably at least 2 mS/cm. A preferred embodiment is the solid sulfide electrolyte according to the invention having an ionic conductivity of less than 5 mS/cm, more preferably less than 4 mS/cm, most preferably less than 3 mS/cm. A preferred embodiment is the solid sulfide electrolyte according to the invention having a ionic conductivity between 1 and 5 mS/cm, preferably between 1.5 and 4 mS/cm, most preferably between 2 and 3 mS/cm.

A preferred embodiment is the solid sulfide electrolyte according to the invention having an electronic conductivity of at least 1×10⁻⁷ mS/cm, preferably at least 1×10⁻⁶ mS/cm, most preferably at least 1×10⁻⁵ mS/cm. A preferred embodiment is the solid sulfide electrolyte according to the invention having an electronic conductivity of less than 1×10⁻² mS/cm, preferably less than 1×10⁻³ mS/cm, most preferably less than 1×10⁻⁴ mS/cm. A preferred embodiment is the solid sulfide electrolyte according to the invention having an electronic conductivity between 1×10⁻⁷ and 1×10⁻² mS/cm, preferably between 1×10⁻⁶ and 1×10⁻³ mS/cm, most preferably between 1×10⁻⁵ and 1×10⁻⁴ mS/cm.

### Battery

A fourth aspect of the invention concerns a battery comprising a negative electrode, a positive electrode and a solid electrolyte layer, wherein at least one of the cathode, the anode and the solid electrolyte layer comprises the solid sulfide electrolyte according to the invention, such as the solid sulfide electrolyte obtainable by the method according to the invention and/or the solid sulfide electrolyte having an argyrodite-type crystal structure according to the invention. The present solid sulfide electrolyte of the invention can be used as a solid electrolyte layer of a solid lithium ion battery or a solid lithium primary cell, or as a solid electrolyte that is mixed with an electrode mixture for a positive electrode or a negative electrode.

As appreciated by the skilled person a negative electrode is an anode and a positive electrode is a cathode. Hence, the present invention concerns a battery comprising a negative electrode, a positive electrode and a solid electrolyte layer, wherein at least one of the positive electrode, the negative electrode and the solid electrolyte layer comprises the solid sulfide electrolyte according to the invention.

In a preferred embodiment the battery is a solid-state battery, preferably a lithium solid-state battery.

### Use

A fifth aspect of the invention concerns a use of the solid sulfide electrolyte according to the invention, such as the solid sulfide electrolyte obtainable by the method according to the invention and/or the solid sulfide electrolyte having an argyrodite-type crystal structure according to the invention, in a battery, preferably a solid-state-battery, more preferably a lithium solid-state-battery.

A sixth aspect of the present invention concerns a use of the battery according to invention in either one of a portable computer, a tablet, a mobile phone, an energy storage system, an electric vehicle or in a hybrid electric vehicle, preferably in an electric vehicle or in a hybrid electric vehicle.

The invention is further illustrated in the following examples.

### Examples

### Description of Testing Methods

### XRD Analysis

Crystallographic phase identification was performed using a Bruker D8 Advanced diffractometer with Cu radiation (λ₁=1.54056 Å, λ₂=1.54439 Å). A stainless steel cell with beryllium window was used to prevent air exposure.

### Ionic Conductivity

Ionic conductivity was measured on a pellet cell, which was pressed with a pressure of 5 T on a sample with a diameter of 10 mm and a total mass of the sample of 120 mg. The pellet was transferred to a plastic sleeve (10.2 mm diameter) with stainless steel plungers having carbon paper on both sides. 80 kg/cm² was applied on the plungers using metal clamp and torque wrench. Ionic conductivity was measured using electrochemical impedance spectroscopy (EIS) at room temperature (25° C.) in the range 1 Hz-30 MHz, using MTZ-35 impedance analyzer from Biologic.

### Electronic Conductivity

Electronic conductivity was measured by chronoamperometry at 25° C. on the same sample as ionic conductivity via step-wise potentiostatic polarization at 0.2, 0.4, 0.6 V and 0.8 V.

### NMR Analysis

NMR spectra were acquired in the temperature range of 100 to 300 K using a Bruker 400 MHz (9.4 T) Ascend DNP-NMR spectrometer equipped with a 3.2 mm MAS DNP-NMR triple resonance broadband X/Y/H magic angle spinning (MAS) probe while spinning at a rate of 8 kHz. At each temperature point, the sample temperature was calibrated using the T1 of 79Br in KBr. (35) For the 23Na measurements, the probe was tuned to 105.9 MHz and a zg experiment with a n/2 pulse of 6 μs at 10 W was used to selectively excite the central transition. The recycle delay was set to 40 s. 23Na spectra are reported with respect to the chemical shift of a 1.0 M solution of NaCl in water set to 0 ppm. For ³¹P spectra, the probe was tuned to 162.0 MHz and a zg experiment with a n/6 pulse of 1 μs at 160 W was used. The recycle delay was set to 200 s. The ³¹P spectra are reported with respect to the chemical shift of solid triphenylphosphine set to −9 ppm. Quantification of the different phases is performed through a fitting in Origin (Pseudo-Voigt) followed by calculating the phase percentage from the peak area. Alternatively, The ³¹P measurements were performed on a 500 MHz (11.7 T) WB (wide bore) Bruker Avance NMR Spectrometer for solids, using a 2.5 mm double resonance broadband probe spinning at 30 kHz. Experiments were run using a spin echo pulse program. A relaxation delay of 10 or 20 seconds was used depending on the sample.”

### Examples

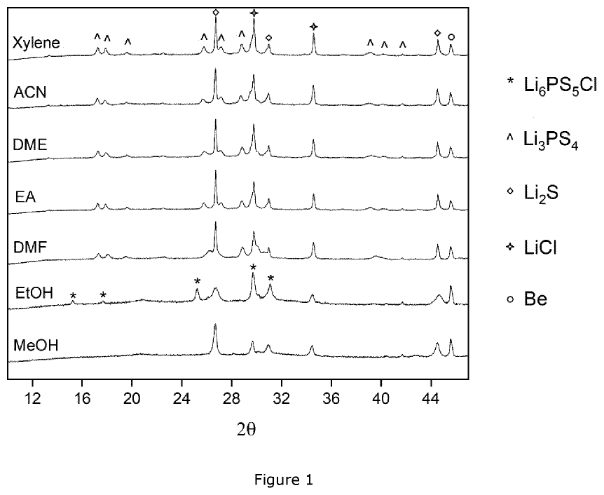

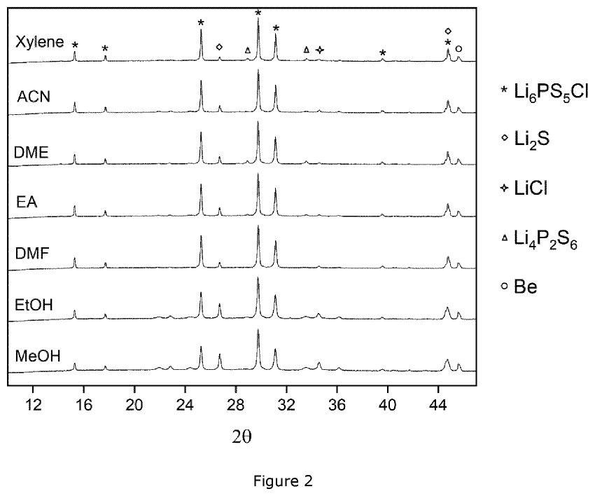

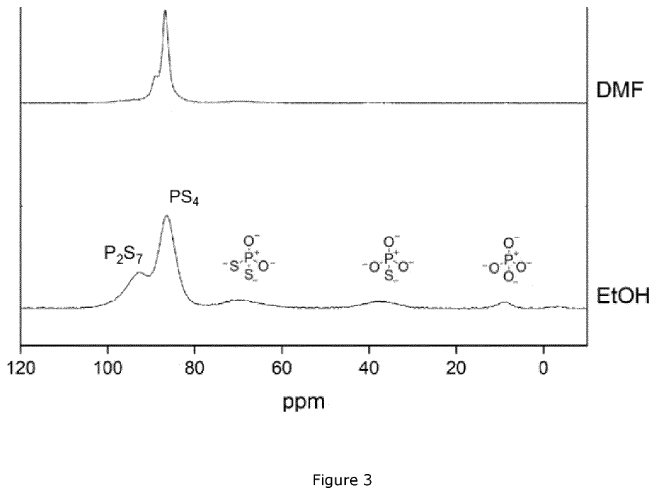

A precursor mixture containing lithium sulfide (Li₂S, 0.1712 g), lithium chloride (LiCl, 0.1580 g) and lithium thiophosphate (Li₃PS₄, 0.6709 g) was prepared in a 1:1:1 molar ratio. This precursor mixture was added to a glass container with a liquid (20 mL). The total solid content is about 5% based on the total weight of the mixture. Table 1 shows all the tested liquids, their water content as determined via Karl-Fish titration and the solubility of LiCl, Li₂S, Li₃PS₄ and Li₆PS₅Cl in these solvents, wherein “yes” means that the corresponding compound is completely dissolved, “partly” means that the corresponding compound is partially dissolved and “no” means that the corresponding compound is not dissolved. The resulting solution was stirred for 24 h at 25° C. The solvent was then removed through evaporation by using a rotavapor. The resulting mixture was then further dried under vacuum with a gradual temperature increase of 80° C. for 1 hour, 100° C. for 1 hour and 150° C. for 18 hours. FIG. 1 shows the XRD spectrum before calcination: CEX1 observes formation of Li₆PS₅Cl; CEX2 observes only LiCl and Li₂S and no Li₆PS₅Cl formation; EX1-5 observes no Li₆PS₅Cl formation; the beryllium peak (Be) comes from the sample holder which has a beryllium window. The dried mixture was then pressed to a pellet and calcinated in stainless steel autoclave with alumina crucible at 525° C. for 6 hours with a ramp time of 2 hours with 4.2° C. per minute affording Li₆PS₅Cl. Table 2 shows the results of the ionic and electronic conductivity of each solvent. FIG. 2 shows the XRD spectrum after calcination: Li₆PS₅Cl is observed for CEX1-2 and EX1-5. XRD analysis demonstrates that EX1 has 78.95% Li₆PS₅Cl, 4.78% Li₂S, 1.75% LiCl and remainder of decomposition products; EX3 has 71.46% Li₆PS₅Cl, 6.17% Li₂S, 1.95% LiCl and remainder of decomposition products; EX4 has 74.35% Li₆PS₅Cl, 5.82% Li₂S, 1.80% LiCl and remainder of decomposition products and EX5 has 77.83% Li₆PS₅Cl, 4.18% Li₂S, 2.85% LiCl and remainder of decomposition products. FIG. 3 shows the ³¹P NMR spectra of EX1 before calcination and CEX1 before calcination. Quantification of the peak area (see Table 3) shows that the reaction in EtOH before calcination results in a higher amount of degradation products as compared to DMF as a liquid, in particular degradation products having PSO₃³⁻ units. ³¹P NMR analysis showed that EX1 after calcination has 98.7% of PS₄³⁻ units and 1.2% PO₄³⁻ units.

TABLE 1
list of solvents, the water content of the solvents and the
solubility of LiCl, Li₂S, Li₃PS₄ and Li₆PS₅Cl in the solvent.

| | | | Solubility precursors and Li₆PS₅Cl in solvent | | | |
|---|---|---|---|---|---|---|
| | liquid | Water content¹ | LiCl | Li₂S | Li₃PS₄ | Li₆PS₅Cl |
| CEX1 | EtOH | 47 ppm | Yes | Yes | Yes | Yes |
| CEX2 | MeOH | n.d.² | n.d. | n.d. | n.d. | n.d. |
| EX1 | DMF | 9 ppm | Yes | No | Yes | No |
| EX2 | EtOAc | 0.2 ppm | No | No | No | No |
| EX3 | DME³ | 79 ppm | n.d. | n.d. | n.d. | n.d. |
| EX4 | CH₃CN | 90 ppm | No | No | Partly | No |
| EX5 | p-Xylene | 12 ppm | No | No | No | No |
| EX6 | DMSO | n.d. | Yes | No | Partly | Partly |
| EX7 | butanethiol | n.d. | No | No | No | No |
| EX8 | Ethylene | n.d. | Yes | Yes | Yes | No |
| | diamine | | | | | |

¹determined via Karl-Fisher titration
²not determined
³dimethoxyethane

TABLE 2
ionic and electronic conductivities for CEX1-2 and EX1-5

| | Ionic conductivity (mS/cm) | Electronic conductivity (mS/cm) |
|---|---|---|
| CEX1 | 0.85 | 5.84 × 10⁻⁶ |
| CEX2 | 0.4 | 4.79 × 10⁻⁶ |
| EX1 | 2.2 | 9.68 × 10⁻⁶ |
| EX2 | 1.8 | 4.85 × 10⁻⁵ |
| EX3 | 1.95 | 3.11 × 10⁻⁵ |
| EX4 | 2.0 | 2.03 × 10⁻⁵ |
| EX5 | 1.7 | n.d.¹ |

¹not determined

TABLE 3
³¹P NMR quantification of each phase
of EX1 and CEX1 before calcination.

| | PS₄³⁻ | P₂S₇⁴⁻ | PS₂O₂³⁻ | PSO₃³⁻ | PO₄³⁻ |
|---|---|---|---|---|---|
| | (%) | (%) | (%) | (%) | (%) |
| EX1 before | 75.2 | 19.4 | 5.1 | 0.3 | — |
| calcination | | | | | |
| CEX1 before | 53.4 | 27.6 | 8.3 | 7.7 | 3.0 |
| calcination | | | | | |

1-16. (canceled)

17. A method for manufacturing a solid sulfide electrolyte comprising the consecutive steps:
i. providing an electrolyte precursor mixture comprising a solid electrolyte precursor mixture comprising Li₂S, Li₃PS₄, and LiX and a liquid not comprising a hydroxyl moiety;
ii. mixing of the electrolyte precursor mixture obtained in step (i); and
iii. heat-treating of the mixed electrolyte precursor mixture obtained in step (ii) to obtain a solid sulfide electrolyte having an argyrodite-type crystal structure;
wherein X is a halogen selected from F, Cl, Br, I, or a combination thereof.

18. The method according to claim 17, wherein the liquid not comprising a hydroxyl moiety is an organic liquid.

19. The method according to claim 17, wherein the liquid not comprising a hydroxyl moiety is selected from the group consisting of a hydrocarbon, an ester, a ketone, an aldehyde, an ether, a nitrile, an amine, an amide, a carbonate, a sulfoxide, a sulfone, a sulfonate, a thiol, a fluorine-based compound and a combination thereof.

20. The method according to claim 17, wherein step (ii) further comprises the following steps:
(ii)a mixing of the electrolyte precursor mixture obtained in step (i), and
(ii)b drying of the mixed electrolyte precursor obtained in step (ii)a thereby affording a solid electrolyte mixture.

21. The method according to claim 17, wherein the solid sulfide electrolyte is represented by formula (I) 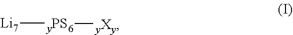
wherein y is 0.8 to 1.7.

22. The method according to claim 17, wherein the solid sulfide electrolyte is represented by formula (II)

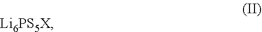

23. The method according to claim 17, wherein the mixing of the electrolyte precursor mixture occurs at a mixing time between 1 hour and 72 hours.

24. The method according to claim 17, wherein the molar ratios of Li₂S:Li₃PS₄:LiX is 1:1:1.

25. The method according to claim 17, wherein X═Cl, Br, I or combinations thereof.

26. The method according to claim 17, wherein the heat-treating occurs at a temperature between 10° and 1000° C.

27. The method according to claim 17, wherein the heat-treating occurs between 0.5 hour and 24 hours.

28. The solid sulfide electrolyte obtainable by the method according to claim 17.

29. A solid sulfide electrolyte having an argyrodite-type crystal structure having a purity of more than 70% as determined via XRD.

30. The solid sulfide electrolyte according to claim 29, having a purity of at least 95%, as determined via ³¹P NMR.

31. The solid sulfide electrolyte according to claim 29, represented by formula (I) 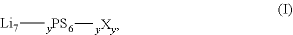
wherein y is 0.8 to 1.7.

32. A battery comprising a negative electrode, a positive electrode, and a solid electrolyte layer, wherein at least one of the positive electrode, the negative electrode, and the solid electrolyte layer comprises the solid sulfide electrolyte, according to claim 29.
